(19) United States
(12) Patent Application Publication
(10) Pub. No.: US 2022/0293042 A1
(43) Pub. Date: Sep. 15, 2022

(54) Light source module and display device

(71) Applicant: Nano Precision Taiwan Limited, HSINCHU COUNTY (TW)

(72) Inventors: KO-WEI CHIEN, HSINCHU COUNTY (TW); CHING-NAN CHUANG, HSINCHU COUNTY (TW)

(21) Appl. No.: 17/676,256

(22) Filed: Feb. 21, 2022

(30) Foreign Application Priority Data
Mar. 10, 2021 (CN) 202120505758.6

(51) Int. Cl. G09G 3/32; G02F 1/13357; G02F 1/1335

(52) U.S. Cl. CPC G09G 3/32; G02F 1/133603; G02F 1/133614; G09G 2310/08; G09G 2300/0452; H01L 33/60

(57) ABSTRACT

A light source module, including a substrate, a plurality of light-emitting elements, and a quantum dot film is provided. The substrate has a bearing surface, and the plurality of light-emitting elements is disposed on the bearing surface. Each light-emitting element includes a first light-emitting chip and a second light-emitting chip. The first light-emitting chip is adapted to emit blue light. The second light-emitting chip is disposed beside the first light-emitting chip and is adapted to emit red light. The quantum dot film is disposed on the bearing surface, and adapted to convert blue light into green light. The plurality of light-emitting elements is located between the substrate and the quantum dot film. A display device of the invention is further provided.

### CROSS-REFERENCE TO RELATED APPLICATION

This application claims the priority benefit of China application 202120505758.6, filed on 2021 Mar. 10. The entirety of the above-mentioned patent application is hereby incorporated by reference herein and made a part of this specification.

### FIELD OF THE INVENTION

The invention relates to a light source module, and more particularly to a light source module that may be used in a display device and a display device using the light source module.

### BACKGROUND OF THE INVENTION

A liquid crystal display device includes a liquid crystal display panel and a backlight module. Because the liquid crystal display panel itself does not emit light, it is necessary to rely on the backlight module to provide a display light source to the liquid crystal display panel. Therefore, the main function of the backlight module is to provide the display light source with high brightness and high uniformity.

Traditionally, the backlight modules may be divided into edge type backlight modules and direct type backlight modules. Generally speaking, the light-emitting element used in the direct type backlight module will add phosphor powder to the packaged light-emitting diode (LED) chip, so that the original light and the converted light after the phosphor conversion are mixed to form a uniformly mixed white light.

However, because the reaction time of the light-emitting diode chip is only tens of nanoseconds but the reaction time of phosphor powder is tens of milliseconds, the converted light after phosphor conversion will have a response time delay when the pixels of the liquid crystal display panel are switched, and a streak phenomenon will be formed on the display screen.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a light source module, which may improve the light uniformity.

The invention provides a display device, which may reduce the streak phenomenon on the display screen.

Other advantages and objects of the invention may be further illustrated by the technical features broadly embodied and described as follows.

In order to achieve one or a portion of or all of the objects or other objects, a light source module provided in an embodiment of the invention includes a substrate, a plurality of light-emitting elements, and a quantum dot film. The substrate has a bearing surface, and the plurality of light-emitting elements is disposed on the bearing surface. Each light-emitting element includes a first light-emitting chip and a second light-emitting chip. The first light-emitting chip is adapted to emit blue light. The second light-emitting chip is disposed beside the first light-emitting chip and is adapted to emit red light. The quantum dot film is disposed on the bearing surface, and the plurality of light-emitting elements is located between the substrate and the quantum dot film. The quantum dot film is adapted to convert blue light into green light.

In order to achieve one or a portion of or all of the objects or other objects, a display device provided in an embodiment of the invention includes a display panel and the above-mentioned light source module. The display panel is disposed on a light emitting side of the light source module.

In the light source module of the embodiment of the invention, each light-emitting element includes a first light-emitting chip adapted to emit blue light and a second light-emitting chip adapted to emit red light, and part of the blue light is converted into green light by the quantum dot film, so the light emitted may be mixed into white light. Since the light source module of the embodiment of the invention directly uses the second light-emitting chip adapted to emit red light, a reaction time of the first light-emitting chip and a reaction time of the second light-emitting chip are approximately the same. Compared with the prior art using phosphor powders to convert blue light into red light, the light source module of the embodiment of the invention is not prone to have the phosphor conversion reaction time delay. The light of each color may be uniformly mixed into white light, so the light uniformity may be improved. Since the display device of the embodiment of the invention uses the above-mentioned light source module, a streak phenomenon on the display screen may be reduced.

Other objectives, features and advantages of The invention will be further understood from the further technological features disclosed by the embodiments of The invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic diagram of a display device of one embodiment of the invention;

FIG. 2A is a cross-sectional schematic diagram of a display device of another embodiment of the invention;

FIG. 2B is a cross-sectional schematic diagram of a light-emitting element of another embodiment of the invention;

FIG. 3 is a cross-sectional schematic diagram of a display device of another embodiment of the invention; and

FIG. 4 is a block diagram of a display device of one embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

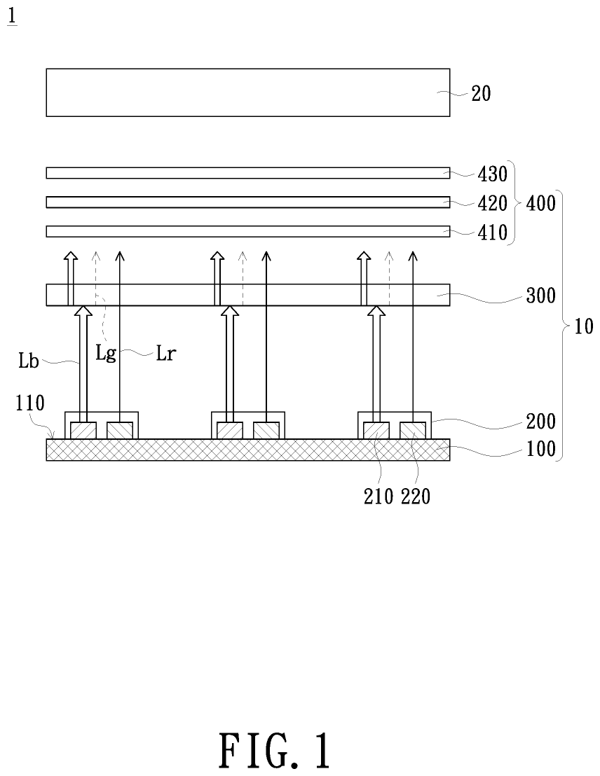

FIG. 1 is a cross-sectional schematic diagram of a display device of one embodiment of the invention. Referring to FIG. 1, a display device 1 of the embodiment includes a light source module 10 and a display panel 20. A light source module 10 includes a substrate 100, a plurality of light-emitting elements 200, and a quantum dot film 300. The substrate 100 has a bearing surface 110, and the plurality of light-emitting elements 200 is disposed on the bearing surface 110. Each light-emitting element 200 includes a first light-emitting chip 210 and a second light-emitting chip 220. In the embodiment, the first light-emitting chip 210 is adapted to emit blue light Lb, for example. The second light-emitting chip 220 is disposed beside the first light-emitting chip 210, and is adapted to emit red light Lr, for example. The quantum dot film 300 is disposed on the bearing surface 110. In order to clearly describe the invention, the quantum dot film 300 is shown separately from the substrate 100 in FIG. 1. The plurality of light-emitting elements 200 is located between the substrate 100 and the quantum dot film 300. The quantum dot film 300 is adapted, for example, to convert blue light Lb into green light Lg. The embodiment is only one of multiple aspects. The invention does not particularly limit the color of the light emitted by the first light-emitting chip 210 and the second light-emitting chip 220, nor does it limit the color of the light converted by the quantum dot film 300. The display panel 20 is disposed on a light emitting side of the light source module 10. Specifically, for example, it is disposed on a side of the quantum dot film 300 facing away from the substrate 100. The display panel 20 may be a liquid crystal display panel or other non-self-luminous display panel, and the type of the liquid crystal display panel may be a transmissive display panel or a transflective display panel. The light source module 10 is adapted to provide light to the display panel 20.

In the embodiment, a wavelength range of the blue light Lb emitted by the first light-emitting chip 210 is, for example, 440 nm to 460 nm, a wavelength range of the red light Lr emitted by the second light-emitting chip 220 is, for example, 620 nm to 645 nm, and a wavelength range of the green light Lg converted by the quantum dot film 300 is, for example, 520 nm to 550 nm, but are not limited thereto. According to different design requirements, the wavelength range of the light emitted by the first light-emitting chip 210 and the second light-emitting chip 220 or the wavelength range of the light converted by the quantum dot film 300 may be adjusted.

Taking the embodiment as an example, green quantum dots are disposed in the quantum dot film 300. Since the green quantum dots only react with light of a specific wavelength, for example, the blue light Lb with a wavelength of 440 nm to 460 nm in the embodiment, there is no reaction to convert the red light Lr when the red light Lr emitted by the second light-emitting chip 220 passes through the quantum dot film 300. Therefore, the light emitted from the quantum dot film 300 includes the blue light Lb emitted by the first light-emitting chip 210, the green light Lg converted from part of the blue light Lb, and the red light Lr emitted by the second light-emitting chip 220, which may then be mixed into white light.

The first light-emitting chip 210 and the second light-emitting chip 220 may be a light-emitting chip that is cut directly from a wafer and not encapsulated, such as a light-emitting diode chip. For example, the first light-emitting chip 210 is a grain level nitride light-emitting diode chip having a dominant wavelength capable of emitting blue light, but is not limited thereto. The quantity of the light-emitting elements 200 in FIG. 1 is three as an example, but the invention does not particularly limit the quantity of the light-emitting elements 200. In the embodiment, each light-emitting element 200 includes, for example, a first light-emitting chip 210 and a second light-emitting chip 220, but is not limited thereto. In other embodiments, each light-emitting element 200 may include a plurality of first light-emitting chips 210 and/or a plurality of second light-emitting chips 220, which are electrically connected to the substrate 100 in a series or parallel manner. In addition, the light-emitting elements 200 are arranged in an array on the bearing surface 110, but are not limited thereto.

The substrate 100 is, for example, a printed circuit board, which may be a rigid board or a flexible board, which is adapted to bear a plurality of light-emitting elements 200 and a quantum dot film 300, and drives the plurality of light-emitting elements 200 to emit light through the substrate 100. The rigid board is, for example, a metal core printed circuit board (MCPCB) or a copper foil substrate (such as a FR4 substrate).

The light source module 10 of the embodiment, for example, further includes at least one optical film 400 disposed on the side of the quantum dot film 300 facing away from the substrate 100. The at least one optical film 400 is, for example, a polarization enhancement film, a diffusion film, a prism sheet or a composite prism sheet, but not limited thereto. The invention does not limit the quantity of the at least one optical film 400, and the quantity of the at least one optical film 400 may be one or more. In the embodiment, the at least one optical film 400 including three optical films 410, 420, 430 are taken as an example. In addition, the optical films 410, 420, 430 may be different types depending on the function of the optical film.

In the light source module 10 of the embodiment, each light-emitting element 200 includes a first light-emitting chip 210 adapted to emit blue light Lb and a second light-emitting chip 220 adapted to emit red light Lr, and part of the blue light Lb is converted into green light Lg by the quantum dot film 300, so the light emitted may be mixed into white light. Since the light source module 10 of the embodiment directly uses the second light-emitting chip 220 adapted to emit red light Lr, a reaction time of the first light-emitting chip 210 and a reaction time of the second light-emitting chip 220 are approximately the same. Compared with the prior art using phosphor powders to convert blue light into red light, the light source module 10 of the embodiment is not prone to have the phosphor conversion reaction time delay. The light of each color may be uniformly mixed into white light, so the light uniformity may be improved. Since the display device 1 of the embodiment uses the light source module 10, a streak phenomenon on the display screen may be reduced.

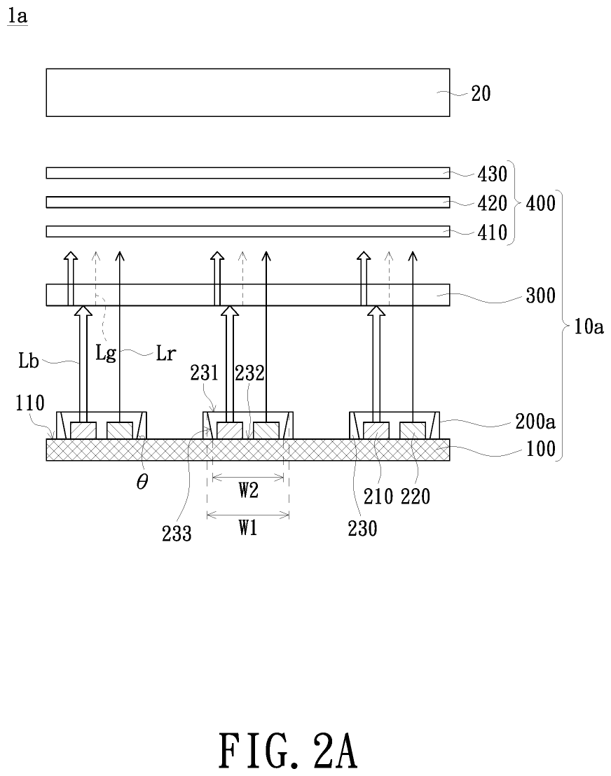

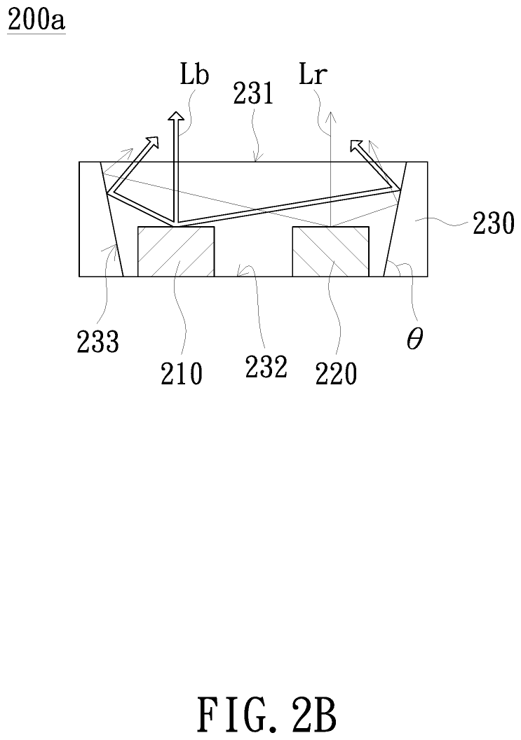

FIG. 2A is a cross-sectional schematic diagram of a display device of another embodiment of the invention. FIG. 2B is a cross-sectional schematic diagram of a light-emitting element of another embodiment of the invention. Referring to FIG. 2A and FIG. 2B, the display device 1a of the embodiment is similar in structure and advantages to the display device 1, and only the main differences in structure are described below. In the display device 1a of the embodiment, each light-emitting element 200a of the light source module 10a further includes a cup-shaped reflective structure 230, a material of which is, for example, white reflective glue, but is not limited thereto. The cup-shaped reflective structure 230 has, for example, an opening 231, a bottom 232, and a reflective side surface 233. The first light-emitting chip 210 and the second light-emitting chip 220 are disposed on the bottom 232. The reflective side surface 233 connects the opening 231 and the bottom 232 and surrounds the first light-emitting chip 210 and the second light-emitting chip 220.

In the embodiment, a maximum width W1 of the opening 231 is greater than a maximum width W2 of the bottom 232, and the reflective side surface 233 is inclined with respect to the bearing surface 110. Specifically, the reflective side surface 233 is inclined outward from the bottom 232 toward the opening 231, and an included angle θ between the reflective side surface 233 and the bearing surface 110 is, for example, 0°-60°. Because the blue light Lb of the first light-emitting chip 210 and the red light Lr of the second light-emitting chip 220 are likely to cause halo of chromatic aberration phenomenon when emitted at the same time, by the configuration of the cup-shaped reflective structure 230, the blue light Lb emitted from the first light-emitting chip 210 to both sides and the red light Lr emitted from the second light-emitting chip 220 to both sides may be mixed before being reflected by the reflective side surface 233 (as shown in FIG. 2B) to reduce the chromatic aberration phenomenon. In addition, since an inclined direction of the reflective side surface 233 is that inclined outward from the bottom 232 toward the opening 231, the reflected light may be concentrated and emitted in the normal direction, which improves the light emitting efficiency of the light-emitting element 200a.

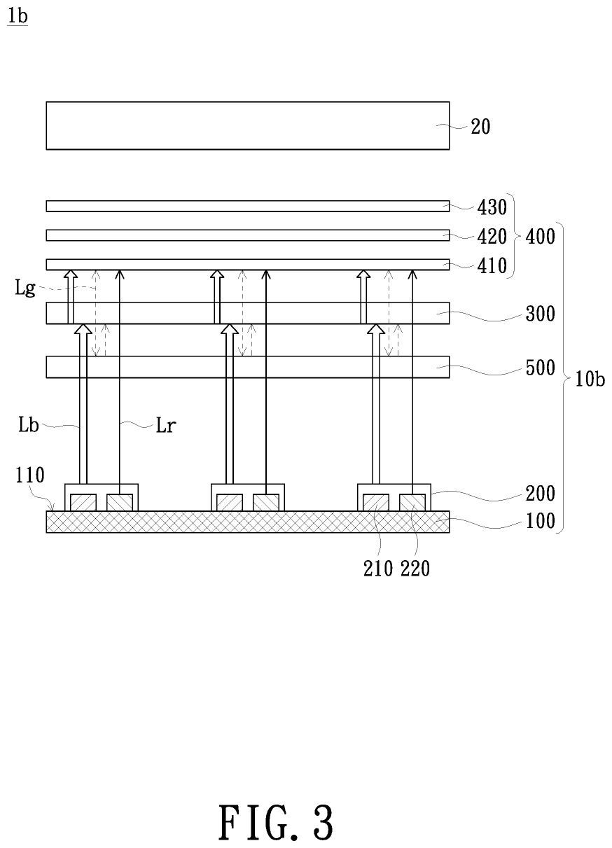

FIG. 3 is a cross-sectional schematic diagram of a display device of another embodiment of the invention. Referring to FIG. 3, the display device 1b of the embodiment is similar in structure and advantages to the display device 1, the only difference is that in the display device 1b of the embodiment, the light source module 10b further includes a dichroic film 500 disposed between the plurality of light-emitting elements 200 and the quantum dot film 300. Generally speaking, the dichroic film 500 is adapted to allow light of certain wavelengths to pass through and reflect light of other wavelengths. In the embodiment, the dichroic film 500 is designed to allow the blue light Lb of the first light-emitting chip 210 and the red light Lr of the second light-emitting chip 220 to pass through, and reflect the green light Lg converted by the quantum dot film 300, but is not limited thereto. When part of the blue light Lb hits the green quantum dots in the quantum dot film 300 and is converted into green light Lg, part of the green light Lg will be emitted toward the substrate 100. Therefore, a dichroic film 500 is disposed between the plurality of light-emitting elements 200 and the quantum dot film 300, and the part of the green light Lg may be reflected back into the quantum dot film 300, and then being emitted after mixing with other colored lights. Therefore, the configuration of the dichroic film 500 may further improve the light output efficiency of the light-emitting element 200b and the light source module 10b. The dichroic film 500 of the embodiment may also be used in combination with the above-mentioned cup-shaped reflective structure 230, and the invention does not limit the combination of the components.

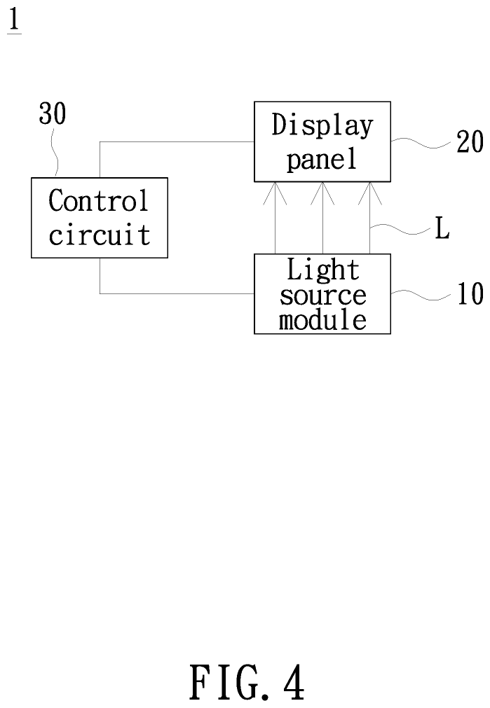

FIG. 4 is a block diagram of a display device of one embodiment of the invention. Referring to FIG. 1 and FIG. 4, the display device 1 of the embodiment, for example, further includes a control circuit 30. The light source module 10 is adapted to provide a uniformly mixed surface light source L to the display panel 20. The display panel 20 has a plurality of pixels (not shown), and each light-emitting element 200 in the light source module 10 corresponds to a part of the plurality of pixels, for example. The control circuit 30 is adapted to control each light-emitting element 200 and a plurality of pixels respectively, in which the control circuit 30 is used to control the switch of each light-emitting element 200 and a part of the plurality of pixels in a time sequence. As described above, the first light-emitting chip 210 and the second light-emitting chip 220 in each light-emitting element 200 may be electrically connected to the substrate 100 in a series or parallel manner. Therefore, the control circuit 30 may control the color light emitted by each light-emitting element 200 and correspond to a part of the plurality of pixels. When the pixels are turned on, the adjusted color light is displayed on the display screen, and when the pixels are turned off, they are not displayed on the display screen, thereby achieving the effect of local dimming on the entire display screen.

In summary, in the light source module of the embodiment of the invention, each light-emitting element includes a first light-emitting chip adapted to emit blue light and a second light-emitting chip adapted to emit red light, and part of the blue light is converted into green light by the quantum dot film, so the light emitted may be mixed into white light. Since the light source module of the embodiment of the invention directly uses the second light-emitting chip adapted to emit red light, a reaction time of the first light-emitting chip and a reaction time of the second light-emitting chip are approximately the same. Compared with the prior art using phosphor powders to convert blue light into red light, the light source module of the embodiment of the invention is not prone to have the phosphor conversion reaction time delay. The light of each color may be uniformly mixed into white light, so the light uniformity may be improved. In addition, in the embodiment where the cup-shaped reflective structure or the dichroic film is disposed, the light source module may further improve the light output efficiency. Since the display device of the embodiment of the invention uses the above-mentioned light source module, a streak phenomenon on the display screen may be reduced, and through the control of the control circuit, the effect of local dimming is achieved on the entire display screen.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first light-emitting chip and the second light-emitting chip are only used for distinguishing various elements and do not limit the number of the elements.

What is claimed is:

1. A light source module, comprising:
a substrate, having a bearing surface;
a plurality of light-emitting elements, disposed on the bearing surface, and each of the plurality of light-emitting elements comprising a first light-emitting chip and a second light-emitting chip, wherein
the first light-emitting chip is adapted to emit blue light, and
the second light-emitting chip is disposed beside the first light-emitting chip and is adapted to emit red light; and
a quantum dot film, disposed on the bearing surface, and the plurality of light-emitting elements being located between the substrate and the quantum dot film, wherein the quantum dot film is adapted to convert blue light into green light.

2. The light source module according to claim 1, wherein each of the plurality of light-emitting elements further comprises a cup-shaped reflective structure, having an opening, a bottom, and a reflective side surface, the first light-emitting chip and the second light-emitting chip are disposed on the bottom, and the reflective side surface connects the opening and the bottom and surrounds the first light-emitting chip and the second light-emitting chip.

3. The light source module according to claim 2, wherein a maximum width of the opening is greater than a maximum width of the bottom, the reflective side surface is inclined with respect to the bearing surface, and an included angle θ between the reflective side surface and the bearing surface is 0°-60°.

4. The light source module according to claim 1, wherein a wavelength range of the blue light emitted by the first light-emitting chip is 440 nm to 460 nm, and a wavelength range of the red light emitted by the second light-emitting chip is 620 nm to 645 nm.

5. The light source module according to claim 1, further comprising a dichroic film, disposed between the plurality of light-emitting elements and the quantum dot film.

6. The light source module according to claim 1, wherein the plurality of light-emitting elements are arranged in an array on the bearing surface.

7. The light source module according to claim 1, further comprising at least one optical film, disposed on a side of the quantum dot film facing away from the substrate.

8. A display device, comprising:
a light source module, comprising:
a substrate, having a bearing surface;
a plurality of light-emitting elements, disposed on the bearing surface, and each of the plurality of light-emitting elements comprising a first light-emitting chip and a second light-emitting chip, wherein
the first light-emitting chip is adapted to emit blue light, and
the second light-emitting chip is disposed beside the first light-emitting chip and is adapted to emit red light; and
a quantum dot film, disposed on the bearing surface, and the plurality of light-emitting elements being located between the substrate and the quantum dot film, wherein the quantum dot film is adapted to convert blue light into green light; and
a display panel, disposed on a light emitting side of the light source module.

9. The display device according to claim 8, further comprising a control circuit to control a switch of each of the plurality of light-emitting elements according to a time sequence.

10. The display device according to claim 9, wherein the display panel has a plurality of pixels, and each of the plurality of light-emitting elements corresponds to a part of the plurality of pixels, wherein the control circuit is adapted to control the switch of the part of the plurality of pixels according to a time sequence.
